(19) United States
(12) Patent Application Publication
(10) Pub. No.: US 2010/0051659 A1
(43) Pub. Date: Mar. 4, 2010

(54) HANGING TAB AND METHOD OF HANGING

(76) Inventor: John Ferrari, Caldwell, NJ (US)

Correspondence Address: John F. Ferrari, 8 Cleveland Street, Caldwell, NJ, 07006, US

(21) Appl. No.: 12/199,863

(22) Filed: Aug. 28, 2008

(51) Int. Cl. B65D 25/22; F16B 2/20

(52) U.S. Cl. 224/197; 24/457; 248/682

(57) ABSTRACT

A tab can be secured to the pliable face of a carrier or other article in order to hang the carrier or article from a slot. The carrier may be a personal carrier with carrying straps, such as a backpack or a bag with carrying handles. The slot can be furnished by a downwardly directed vent slot on a locker door, by a slotted bracket, or by some other slotted device. The disclosed tab is secured at its upper end, reaching a location on the tab at least one quarter of the way from the upper end toward the lower end. The tab normally lies flat against the pliable face, but this face is flexible to allow the lower end of the tab to articulate away from the pliable face. In some cases clothes can be loaded into the personal carrier before inserting its tab into a vent slot in a locker door. The tab is inserted to a depth sufficient to prevent the lower end of the tab from articulating upwardly enough to allow the tab to disengage the vent slot. Then a user can retrieve clothes, books, and other articles from the carrier while the carrier is hung on the locker door.

### BACKGROUND OF THE INVENTION

1. Field of the Invention

The present invention relates to carriers and other products designed to be hung as well as to methods for hanging.

2. Description of Related Art

Storing objects by placing them on the floor is inefficient, disorderly, and requires one to stoop or bend in order to retrieve or inspect objects on the floor. For this reason shelves and various other arrangements exist for holding objects at a more convenient height.

Another common approach is to hang objects. For example clothing or other objects can be hung from a hook. In some cases a cloth loop will be sewn into-the article of clothing to facilitate the hanging. As another example, a brush handle can be hung using a hole or lanyard in the handle.

People are continually in need a devices for carrying objects, whether they are shopping, hiking, visiting a gym, etc. Well-known carriers include backpacks, cloth bags, gym bags, and the like. Some of these carriers will include devices to allow hanging of the carrier. For example, cloth loops may be sewn into the top edge of a backpack so it can be hung on a hook. However, hooks are not always available and this cloth loop may therefore be unusable.

At times hooks are available but are inconvenient. For example, one may be able to hang a backpack from a hook that is inside a gym locker. However, a backpack hung in this fashion will be located relatively deep inside the locker, to so restrict visibility and manual access that rummaging through the backpack is difficult. Consequently, a user will typically place the backpack on a bench or on the floor and then stoop or bend over in order to rummage through the backpack.

See also U.S. Pat. Nos. 4,859,084; 5,474,192; 5,927,840; 6,193,034; and D548,574 and US Patent Publication Nos. 2007/0119883; 2007/0277355; 2008/0035523; and 2008/0095475.

### SUMMARY OF THE INVENTION

In accordance with the illustrative embodiments demonstrating features and advantages of the present invention, there is provided a personal carrying product adapted to hang from a slot. The product has a carrier for holding objects. The carrier has a pliable face and carrying straps. Also included is a tab secured to the pliable face and adapted to be inserted in the slot.

In accordance with another aspect of the invention, a method is provided employing a pliable personal carrier with a tab for use with a downwardly directed vent slot on a locker door. The method includes the step of loading clothes or books into the personal carrier. Another step is carrying the carrier to the locker door and inserting the tab into the vent slot to a depth sufficient to prevent the tab from articulating upwardly enough to allow the tab to disengage the vent slot. The method also includes the step of retrieving the clothes or books from the carrier while hung on the locker door.

In accordance with yet another aspect of the invention there is provided a product adapted to hang from a slot. The product has an article with a pliable surface. Also included is a tab secured to the pliable surface and adapted to be inserted in the slot. The tab has an upper and a lower end and is secured to normally lie flat against the pliable face. The tab is secured at its upper end including at a location on the tab at least one quarter of the way from the upper end toward the lower end. The pliable face is flexible to allow the lower end of the tab to articulate away from the pliable face.

In accordance with yet another aspect of the invention there is provided a personal carrying arrangement comprising a backpack with a pliable face that includes a fabric. The backpack has a pair of shoulder straps with top ends connected at the pliable face. The arrangement also has a tab with an upper and a lower end. The tab is attached to the pliable face equidistantly from the top ends of the shoulder straps by at least one of stitching, riveting, and stapling. The tab is secured at its upper end including at a location on the tab at least one quarter of the way from the upper end toward the lower end. The tab has an inside face and an outside face that are parallel and flat from the upper to the lower end. The tab is secured to normally lie flat against the pliable face. The pliable face is flexible to allow the lower end of the tab to articulate away from the pliable face. The tab has a pair of lateral edges that converge toward the lower end. The tab has an overall width and transverse thereto a longitudinal dimension reaching from the upper to the lower end. The longitudinal dimension exceeds the overall width. The arrangement has a bracket with a longitudinal slot. The bracket is adapted to be attached to a vertical wall with clearance between the longitudinal slot and the wall to allow the tab to be inserted into the longitudinal slot in order to hang the backpack.

By employing apparatus and methods of the foregoing type an improved technique is achieved for hanging articles, such as a personal carrying product. In one embodiment a plastic tab is secured near an upper edge of a backpack on the same side as the shoulder straps. The disclosed tab can have any of a variety of shapes and can be secured by stitches, rivets, staples, etc. The tab is secured along a fraction of its length, leaving a lower portion free to articulate and lift off the backpack. This articulation is accomplished by allowing the pliable fabric of the backpack to flex.

Once lifted in this manner, the tab can be inserted into a slot in order to hang the backpack. For example, the tab can be inserted into one of the vent slots commonly found on locker doors. Once hung on the back of a locker door in this fashion, the backpack is elevated and, once opened, its contents are readily visible. Accordingly, the user can then retrieve the stored objects; for example, exercise clothes and exercise equipment. The user can also store objects that are not currently needed. Thereafter, the locker door can be closed while the backpack remains hanging. The user can return to transfer objects to and from the backpack. The user departs by lifting the backpack to disengage the tab from the vent slot. The backpack can then be carried away in the usual fashion.

Besides backpacks the foregoing tab can be mounted on a variety of articles, including personal carrying products such as cloth bags, gym bags, etc. Also, the tab can be inserted into different slots other than vent slots. In some cases a bracket can be mounted on a wall to provide a slot that is spaced from the wall to provide clearance for the tab.

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein:

FIG. 1 is a perspective view of a product in the form of a personal carrier shown about to be hung from a vent slot of a locker door, in accordance with principles of the present invention;

FIG. 2 is a fragmentary, cross-sectional view of the carrier of FIG. 1 hanging from the vent slot;

FIG. 3 is a front view of the tab on the carrier of FIG. 1, showing its stitches;

FIG. 4 is a fragmentary view of the carrier of FIG. 1, partly in section, and showing its tab lying flat against a pliable face of the carrier;

FIG. 5 is a perspective view of a bracket providing an alternate slot for engaging the tab of FIG. 1;

FIG. 6 is a side view of a tab that is an alternate to that of FIG. 4;

FIG. 7 is a front view of a tab that is riveted in place and is alternate to that of FIG. 3;

FIG. 8 is a front view of a tab that is stapled in place and is alternate to that of FIGS. 3 and 7;

FIG. 9 is a perspective view of a product that is an alternate to that of FIG. 1 in the form of a carrying bag; and

FIG. 10 is a perspective view of a product that is an alternate to that of FIGS. 1 and 9 in the form of a gym bag;

FIG. 11 is a perspective view of a bracket that is an alternate to that of FIG. 5; and

FIG. 12 is a cross-sectional view of the bracket of FIG. 11.

### DETAILED DESCRIPTION OF THE PREFERRED EMBODIMENTS

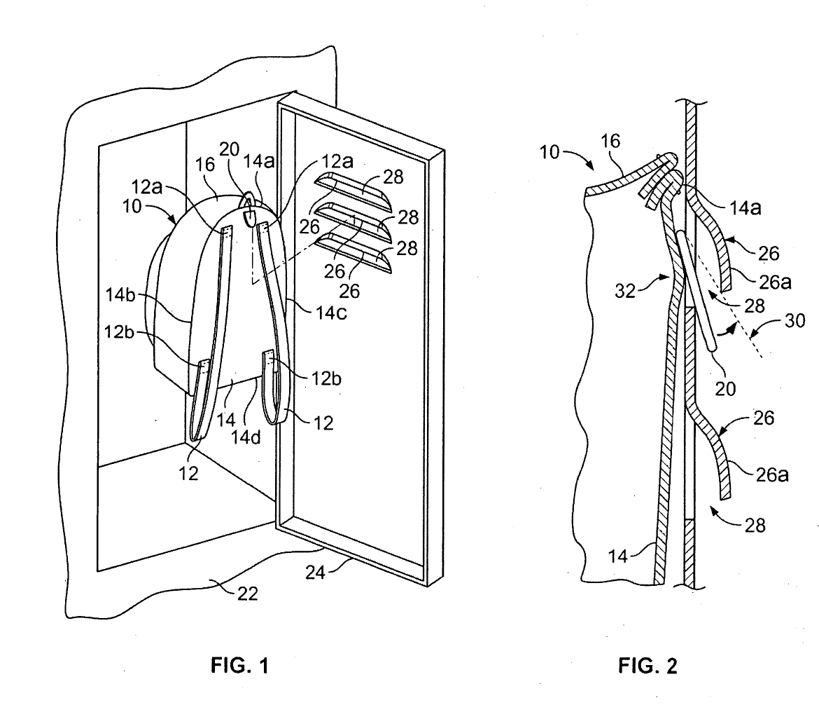

Referring to FIGS. 1-4 a personal carrying product is shown as backpack 10, although it will be understood that in other embodiments different types of carriers (personal or otherwise) may be used. Backpack 10 has a pair of conventional shoulder straps 12, located along the right edge 14B and left edge 14C of inside panel 14 (panel 14 also being referred to as a pliable face). The lower ends 12B of carrying straps 12 are attached near the lower edge 14D of panel 14, and top ends 12A are attached near the upper edge 14A of panel 14. Another panel 16 is stitched or otherwise secured around inside panel 14 and is part of a structure for holding objects. The front of backpack 10 is constructed in a conventional manner and will include zippers or other means for opening and closing the backpack.

Tab 20 is attached to panel 14 near upper edge 14A. Tab 20 is shown centered between right and left edges 14B and 14C, although in other embodiments the tab need not be centered. Even though the upper and lower ends of the right and left edges 14B and 14C are somewhat indistinct, tab 20 will be considered between the right and left edges by construing those edges broadly and, if necessary, extending them as imaginary lines to determine whether the tab is lying between them. Similarly, tab 20 may also be considered located between the upper ends 12A of straps 12.

In this embodiment tab 20 is shown as a plastic or elastomeric plate with an outside face 20-1 and a parallel inside face 20-2, which faces are both flat from their upper to lower ends 20A, 20B. Tab 20 has in this instance a thickness of about ⅛ inch (3.2 mm), an overall longitudinal dimension of about 2¼ inches (5.7 cm) and an overall width of about 1.5 inches (3.8 cm), although other embodiments may employ different materials and may have different dimensions depending upon the desired strength, capacity, size, reliability, rigidity, etc. In this embodiment, tab 20 has a straight edge 20A at its upper end merging through a rounded corner with two lateral edges 20B, which are initially parallel but begin converging together about two thirds of the way toward the tapered lower end 20D.

Tab 20 is secured onto panel 14 by stitches 22 laid down in a rectangular pattern. In some cases a reinforcing backer of leather, fabric, plastic, or the like, may be placed on the opposite side of panel 14 before stitching tab 20 to panel 14 30 and the backer. As shown in this embodiment tab 20 is secured with (1) a proximal course of stitches 22A located at a position about one quarter of the way from the upper end 20A to the lower end 20D,(2) a distal course of stitches 22B located at a position about one half of the way from the upper end 20A to the lower end 20D, and (3) two other courses connecting the first two. Accordingly, tab 20 is free to lift away from underlying panel 14 along about half of the tab's length, that is, the length between stitch course 22B and lower end 20D. In some embodiments the stitching of course 22A can be located closer to or further from the upper end 20A.

In other embodiments tab 20 may be free to lift over a different length. For example, tab 20 may be secured at a location at least one quarter of the way from the upper end 20A to the lower end 20B, leaving the tab free to lift below that location. Alternatively, tab 20 may be secured at a location at least one third of the way from the upper end 20A to the lower end 20B, leaving the tab free to lift below that location. The amount of freedom given to tab 20 will affect its ability to act as a device for hanging an article, in a manner to be described presently.

To facilitate an understanding of the principles associated with the foregoing apparatus, its operation will be briefly described in connection with illustrated locker 22, which has an ordinary door 24 with three conventional vents 26. Vents 26 are preexisting and are made by the manufacturer by punching out an overhanging section 26A from the main door panel to create vent slot 28.

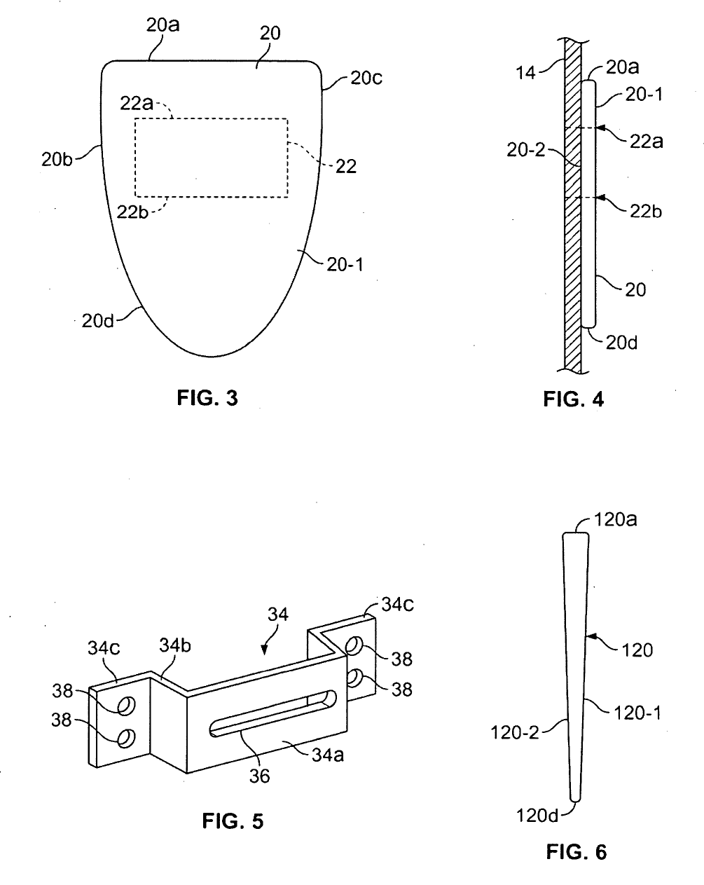

Tab 20 can be lifted somewhat from panel 14 of backpack 10, which lifting is possible because the tab is secured only over a portion of its overall length. In FIG. 2 tab 20 is shown inserted in one of the vent slots 28, having been articulated about 15°. This articulation is accommodated by the flexibility of the fabric of panel 14, which is shown with a wrinkle 32 caused by articulation of tab 20. Because tab 20 is secured by stitches 22 (FIG. 3) lying over an extended region, the attachment forces are distributed accordingly and there is a lesser likelihood of tearing the fabric of panel 14.

Because section 26A overhangs tab 20, tab articulation is limited in this case to about 35°, which limit is shown as ray 33. Therefore, even if panel 14 is highly flexible, tab 22 cannot invert and allow backpack 10 to fall out of vent slot 28. The articulation of tab 20 can also be restricted by extending the region over which the tab is secured. Basically, the lower the location on tab 20 that is secured to the panel 14, the smaller the effective lever arm for lifting the tab and flexing panel 14, and the less likely tab 20 is to articulate or even invert. For this reason, most embodiments will have the tab 20 secured at locations at least one quarter of the way from the upper end 20A to lower end 20D. To restrict articulation even more, some embodiments will secure tab 20 at locations at least one third of the way from the upper end 20A to lower end 20D. In any event, slot 28 or the tab 20 can be configured to prevent undesired disengagement of the tab from the slot.

Backpack 10 may be used to carry exercise clothing and equipment to a gym. Alternatively, the backpack 10 may be used by a student to carry books to a school. Other cargo and destinations are also contemplated. On arrival the user can open locker door 24 and insert tab 20 through one of the vent slots 28. Backpack 10 can either be opened in advance or opened after being hung on tab 20 on the back of locker door 24. Once backpack 10 is hung in this fashion and the backpack is open, the user can retrieve the various stored objects. Since backpack 10 is elevated to make its contents more visible and since the user's hands are free, rummaging through the backpack is convenient. At this time, articles of clothing or other personal items on the user may also be transferred into backpack 10. With this accomplished, the user can close locker door 24 with the backpack 10 still hanging on tab 20, if desired. Backpack 10 can either be kept open or closed, when locker door 24 is closed.

As many times as desired, the user can return and open locker door 24, thereby regaining access to backpack 10. For example, the user may wish to access backpack 10 in order to prepare for a shower or simply to leave. Accordingly, the user can reopen the backpack 10 and insert and remove objects as desired at this time.

When the user wishes to leave, backpack 10 can be lifted to remove tab 20 from vent slot 28, the lifting occurring either before or after the closing of the backpack. Backpack 10 can then be carried away in the usual fashion.

Referring to FIG. 5, the illustrated bracket 34 may be used in place of a locker doors with vent slots of the type of the type just described. Bracket 34 is shown as a metal stamping having a rectangular face 34A with longitudinal slot 36. Perpendicular to face 34A are an integral pair of rectangular support legs 34B extending to a coplanar pair of rectangular, integral feet 34C. Feet 34C are parallel to face 34A with each foot having a pair of mounting holes 38.

Bracket 34 can be mounted to a wall with its longitudinal slot 36 horizontal by inserting fasteners such screws or nails through mounting holes 38. Thereafter, tab 20 of backpack 110 of FIG. 1 can be inserted into slot 36 to extend downwardly using the wall clearance provided by legs 34B. The length of legs 34B can be chosen so that tab 22 can articulate only a limited amount before its lower end 20D hits the wall on which bracket 34 is mounted. Restricting articulation of tab 20 in this manner prevents undesired disengagement of the tab. It will be understood, however, that tab 20 can be secured over so much of its length that it cannot articulate an amount sufficient to disengage from slot 36, regardless of the wall clearance provided by legs 34B.

Referring to FIGS. 11 and 12, an alternate bracket 60 is shown as a wooden block with a pair of mounting holes 64 that may be used to attach the bracket to a wall with a screw or other fastener. Bracket 60 has a downwardly directed slot 62, specifically a mortise descending at about 45°, although other angles of descent are contemplated. Once mounted on a wall or other surface, the previously mentioned tab (for example, tab 20 of FIG. 1) can be inserted into slot 62 to hang an article such as backpack 10 of FIG. 1.

Referring to FIG. 6, alternate tab 120 is the same as the previously illustrated tab except that its outside face 120-1 and inside face 120-2 converge at a non-zero acute angle from upper end 120A to lower end 120D. Elements corresponding to those previously described in connection with tab 20 of FIGS. 1-4 have the same reference numerals but increased by 100. Since tab 120 is tapered, its lower end 120D will have added flexibility to facilitate insertion into a slot. On the other hand, the thicker portions of tab 120 will restrict the net overall articulation of the tab to guard against undesired disengagement.

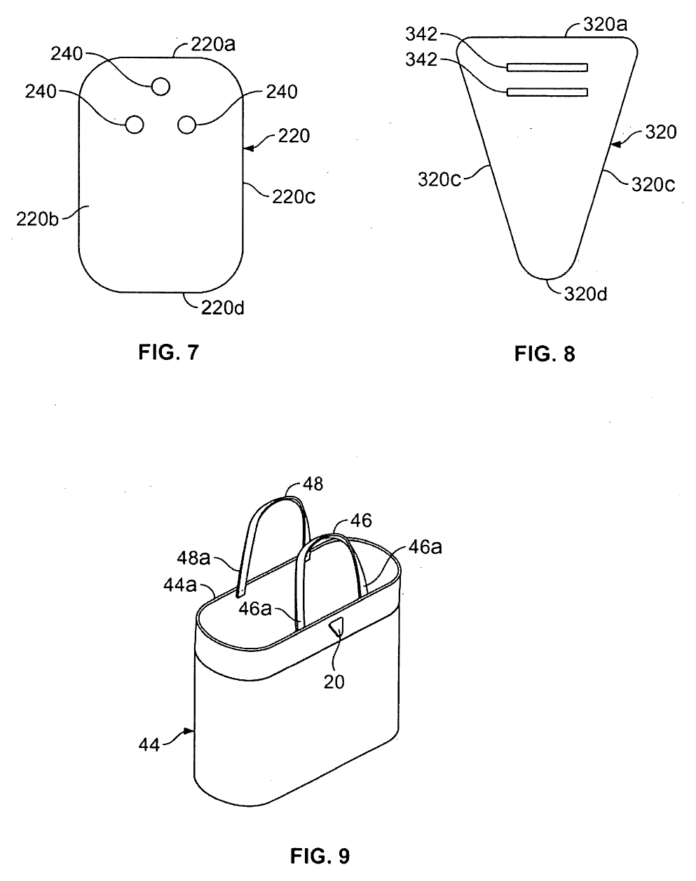

Referring to FIG. 7, alternative tab 220 is an aluminum plate with outside and inside faces that are parallel. Elements corresponding to those previously described in connection with tab 20 of FIGS. 1-4 have the same reference numerals but increased by 200. The outline of tab 220 is essentially a rectangle with rounded corners, although in some embodiments the outline may be trapezoidal with rounded corners and with lateral edges 220B and 220C tapering slightly towards lower end 220D. As before tab 220 may employ various materials and may have different dimensions depending upon the desired strength, capacity, size, reliability, rigidity, etc.

Instead of stitches, tab 220 is fastened using a trio of rivets 240 that are driven through the tab and the underlying pliable fabric (not shown) before being deformed in the usual fashion. Again, the underlying pliable fabric can be sandwiched between tab 220 and a reinforcing backer (not shown).

Referring to FIG. 8, alternative tab 320 is a plastic plate with outside and inside faces that are parallel. Elements corresponding to those previously described in connection with tab 20 of FIGS. 1-4 have the same reference numerals but increased by 300. The outline of tab 320 is essentially a triangle with rounded corners. As before tab 320 may employ various materials and may have different dimensions depending upon the desired strength, capacity, size, reliability, rigidity, etc.

Instead of stitches, tab 320 is fastened using a pair of staples 342 that are driven through the tab and the underlying pliable fabric (not shown) before being deformed in the usual fashion. Again, the pliable fabric can be sandwiched between tab 220 and a reinforcing backer (not shown).

Referring to FIG. 9, previously described tab 20 is shown attached to another article, namely, cloth bag 44. Bag 44 is shown with a pair of handle loops 46 and 48, each having a pair of ends 46A and 48A, respectively. Each of the pair of ends 46A and 48B are attached at spaced positions along opposite sides of rim 44A of bag 44. Tab 20 is shown mounted near rim 44A equidistant from the spaced positions of the ends 46A of handle loop 46. In this embodiment an identical tab (not shown) is mounted on the opposite side of bag 44 near rim 44A and equidistant from the ends 48A of handle loop 48.

In a manner just described in connection with FIGS. 1-4 or FIG. 5, tab 20 can be used to hang bag 44. Instead of tab 20, bag 44 can employ any one of the tabs shown in FIGS. 6-8.

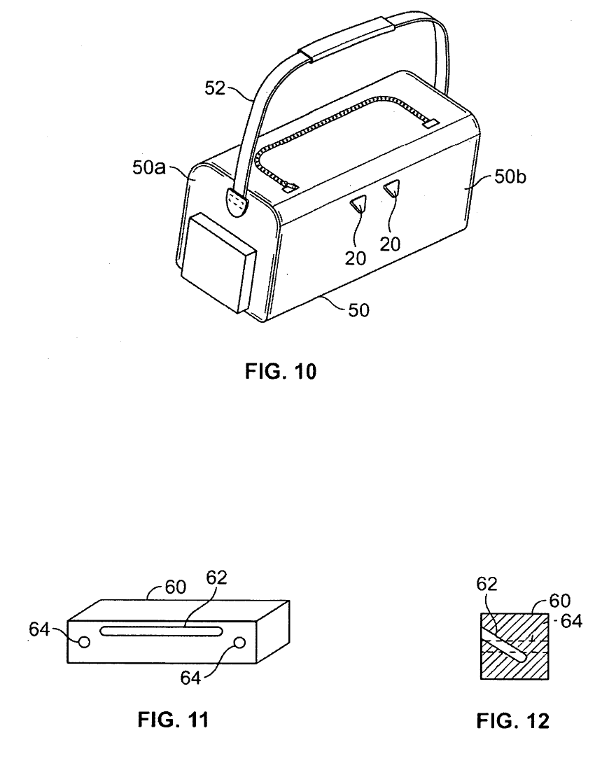

Referring to FIG. 10, gym bag 50 has roughly the shape of a rectangular prism, is formed from fabric and is fitted with a carrying strap 52 attached between opposite ends 50A of the bag. Pliable face 50B of bag 50 is approximately rectangular and a pair of the previously described tabs 20 are mounted symmetrically near the top edge of face 50B.

In a manner just described in connection with FIGS. 1-4, the pair of tabs 20 can be inserted together into one of the vent slots 28 of FIG. 1 in order to hang gym bag 50. For the embodiment of FIG. 5, a pair of brackets 34 can be mounted side-by-side to accommodate the pair of tabs 20 of FIG. 10. Alternatively, face 34A and slot 36 can be lengthened sufficiently to accept together the pair of tabs 20. Again, instead of tab 20, bag 50 can employ any one of the tabs shown in FIGS. 6-8. Also, tabs can be mounted as well on the face of bag 50 opposite face 50B.

Obviously, many modifications and variations of the present invention are possible in light of the above teachings. It is therefore to be understood that within the scope of the appended claims, the invention may be practiced otherwise than as specifically described.

1. A personal carrying product adapted to hang from a slot, comprising:
a carrier for holding objects, said carrier having a pliable face and carrying straps; and
a tab secured to said pliable face and adapted to be inserted in the slot.

2. A personal carrying product according to claim 1 wherein said tab has an upper and a lower end, said tab being secured to said pliable face at said upper end, said pliable face being flexible to allow the lower end of said tab to articulate away from said pliable face.

3. A personal carrying product according to claim 2 wherein said pliable face comprises a fabric.

4. A personal carrying product according to claim 2 wherein said tab has an overall width and transverse thereto a longitudinal dimension reaching from the upper to the lower end, said longitudinal dimension exceeding said overall width.

5. A personal carrying product according to claim 4 wherein said tab has a pair of lateral edges that converge toward the lower end.

6. A personal carrying product according to claim 4 wherein said pliable face has a right and a left edge, said tab being centered between the right and the left edge.

7. A personal carrying product according to claim 2 wherein said tab is stitched to said pliable face.

8. A personal carrying product according to claim 2 wherein said tab is secured to said pliable face by at least one of stitching, riveting, and stapling.

9. A personal carrying product according to claim 2 wherein said tab is secured to said pliable face at least at a location that is at least one quarter of the way from the upper end toward the lower end.

10. A personal carrying product according to claim 2 wherein said tab is secured to said pliable face at least at a location that is at least one third of the way from the upper end toward the lower end.

11. A personal carrying product according to claim 1 wherein said tab has an upper and a lower end, said tab having an inside face that is flat from the upper to the lower end and is secured to normally lie flat against said pliable face.

12. A personal carrying product according to claim 11 wherein said tab has an outside face that is flat from the upper to the lower end.

13. A personal carrying product according to claim 12 wherein said outside and said inside face are parallel.

14. A personal carrying product according to claim 12 wherein said outside face lies at a non-zero acute angle to said inside face.

15. A personal carrying product according to claim 1 wherein said carrier comprises:
a backpack with a pair of shoulder straps with top ends connected at said pliable face, said tab being attached between said pair of shoulder straps at said top ends of said shoulder straps.

16. A personal carrying product according to claim 1 wherein said carrier comprises:
a bag with an opposing pair of handle loops each connected at a pair of spaced positions along the rim of said bag, said tab being attached approximately equidistant from the pair of spaced positions of one of said pair of handle loops.

17. A personal carrying product according to claim 1 comprising:
a bracket having a longitudinal slot and adapted to be attached to a vertical wall with clearance between said longitudinal slot and the wall to allow said tab to be inserted into said longitudinal slot.

18. A method employing a pliable personal carrier with a tab for use with a downwardly directed vent slot on a locker door, the method including the steps of:
loading clothes or books into the personal carrier;
carrying the carrier to the locker door and inserting the tab into the vent slot to a depth sufficient to prevent the tab from articulating upwardly enough to allow the tab to disengage the vent slot; and
retrieving the clothes or books from the carrier while hung on the locker door.

19. A method according to claim 18 wherein the step of inserting the tab is performed by articulating the tab to flex portions of said personal carrier.

20. A method according to claim 19 comprising the step of:
closing the locker door with the personal carrier hung on the vent slot.

21. A method according to claim 20 comprising the steps of:
opening the locker door;
removing the tab from the vent slot; and
carrying away the personal carrier.

22. A method according to claim 21 comprising the steps of:
opening and closing the carrier while hung on the locker door.

23. A product adapted to hang from a slot, comprising:
an article having a pliable surface; and
a tab secured to said pliable surface and adapted to be inserted in the slot, said tab having an upper and a lower end and being secured to normally lie flat against said pliable face, said tab being secured at its upper end including at a location on said tab at least one quarter of the way from the upper end toward the lower end, said pliable face being flexible to allow the lower end of said tab to articulate away from said pliable face.

24. A product according to claim 23 wherein said tab has an inside face and an outside face that are flat from the upper to the lower end.

25. A product according to claim 24 wherein said tab has an overall width and transverse thereto a longitudinal dimension reaching from the upper to the lower end, said longitudinal dimension exceeding said overall width.

26. A personal carrying arrangement comprising:
a backpack with a pliable face that includes a fabric, said backpack having a pair of shoulder straps with top ends connected at said pliable face, and
a tab having an upper and a lower end and being attached to said pliable face equidistantly from said top ends of said shoulder straps by at least one of stitching, riveting, and stapling, said tab being secured at its upper end including at a location on said tab at least one quarter of the way from the upper end toward the lower end, said tab having an inside face and an outside face that are parallel and flat from the upper to the lower end, said tab being secured to normally lie flat against said pliable face, said pliable face being flexible to allow the lower end of said tab to articulate away from said pliable face, said tab having a pair of lateral edges that converge toward the lower end, said tab having an overall width and transverse thereto a longitudinal dimension reaching from the upper to the lower end, said longitudinal dimension exceeding said overall width; and
a bracket having a longitudinal slot and adapted to be attached to a vertical wall with clearance between said longitudinal slot and the wall to allow said tab to be inserted into said longitudinal slot in order to hang said backpack.
